(19) United States
(12) Patent Application Publication
(10) Pub. No.: US 2019/0143681 A1
(43) Pub. Date: May 16, 2019

(54) LIQUID JET HEAD AND LIQUID JET RECORDING DEVICE

(71) Applicant: SII Printek Inc., Chiba-shi (JP)

(72) Inventors: Naohiro TOMITA, Chiba-shi (JP); Yuki YAMAMURA, Chiba-shi (JP); Masaru MIDORIKAWA, Chiba-shi (JP); Shuji SATO, Chiba-shi (JP); Shunsuke YAMAZAKI, Chiba-shi (JP)

(21) Appl. No.: 16/186,941

(22) Filed: Nov. 12, 2018

(30) Foreign Application Priority Data
Nov. 13, 2017 (JP) 2017-218084

(51) Int. Cl. B41J 2/14

(52) U.S. Cl. CPC B41J 2/1433; B41J 2002/14491

(57) ABSTRACT

There is provided a liquid jet head capable of enhancing the operation reliability. The liquid jet head is provided with an actuator plate having conductivity and a plurality of channels filled with liquid, a nozzle plate having conductivity which is electrically insulated from the actuator plate, and has a plurality of nozzle holes from which the liquid filled in the plurality of channels is jetted, a base having conductivity adapted to support each of the actuator plate and the nozzle plate, and a protective member having conductivity, adapted to cover at least a part of a surface of the nozzle plate in an area where the plurality of nozzle holes is not disposed on a side from which the liquid is jetted, and electrically connected to each of the nozzle plate and the base.

### RELATED APPLICATIONS

This application claims priority under 35 U.S.C. § 119 to Japanese Patent Application No. 2017-218084 filed on Nov. 13, 2017, the entire content of which is hereby incorporated by reference.

### BACKGROUND OF THE INVENTION

### 1. Field of the Invention

The present disclosure relates to a liquid jet head for jetting a liquid, and a liquid jet recording device using the liquid jet head.

### 2. Description of the Related Art

As a recording device for recording an image, and so on, on a recording target medium, there is known a liquid jet recording device equipped with a liquid jet head.

In the liquid jet recording device, a liquid is jetted from the liquid jet head to the recording target medium to thereby record an image, and so on, on the recording target medium.

Regarding the configuration of the liquid jet recording device, there have been made a variety of studies. Specifically, in order to prevent the noise from being radiated outside a liquid jet device equipped with a jet head, there are used a head cover having conductivity for covering the periphery of a liquid ejection surface, and a conductive section for electrically connecting the head cover to a main frame in the jet head (see, e.g., JP-A-2005-111933). In this case, an electric resistance of the conductive section is made larger than an electric resistance of the head cover.

Although a variety of studies have been made regarding the configuration of the liquid jet recording device equipped with the liquid jet head, the operation reliability of the liquid jet recording device is not yet sufficient, and therefore has room for improvement.

Therefore, it is desired to provide a liquid jet head and a liquid jet recording device capable of enhancing the operation reliability.

### SUMMARY OF THE INVENTION

A liquid jet head according to an embodiment of the disclosure is provided with an actuator plate having conductivity and a plurality of channels filled with liquid, a nozzle plate having conductivity which is electrically insulated from the actuator plate, and has a plurality of nozzle holes from which the liquid filled in the plurality of channels is jetted, a base having conductivity adapted to support each of the actuator plate and the nozzle plate, and a protective member having conductivity, adapted to cover at least a part of a surface of the nozzle plate in an area where the plurality of nozzle holes is not disposed on a side from which the liquid is jetted, and electrically connected to each of the nozzle plate and the base.

A liquid jet recording device according to an embodiment of the disclosure is provided with a liquid jet head adapted to jet a liquid to a recording target medium, and a liquid storage section adapted to store the liquid, and the liquid jet head has substantially the same configuration as that of the liquid jet head according to the embodiment of the disclosure described above.

According to each of the liquid jet head and the liquid jet recording device related to the embodiment of the disclosure, since the nozzle plate having conductivity is electrically insulated from the actuator plate having conductivity, and at the same time, the protective member having conductivity is electrically connected to each of the nozzle plate having conductivity and the base having conductivity, it is possible to enhance the operation reliability.

### BRIEF DESCRIPTION OF THE DRAWINGS

FIG. 1 is a perspective view showing a configuration of a liquid jet recording device (a liquid jet head) according to an embodiment of the disclosure.

FIG. 2 is a diagram schematically showing a configuration of the circulation mechanism shown in FIG. 1.

FIG. 3 is a perspective view showing a configuration (a state in which a protective frame is detached from a nozzle plate) of a principal part of the liquid jet head shown in FIG. 1.

FIG. 4 is a perspective view showing a configuration (a state in which the protective frame is attached to the nozzle plate) of the principal part of the liquid jet head shown in FIG. 1.

FIG. 5 is a cross-sectional view showing a configuration of the liquid jet head along the line A-A shown in FIG. 4.

FIG. 6 is a cross-sectional view showing a configuration of the liquid jet head along the line B-B shown in FIG. 4.

FIG. 7 is a perspective view showing respective configurations of the nozzle plate, the actuator plate, and the cover plate shown in FIG. 3.

FIG. 8 is a plan view showing the configuration of the actuator plate shown in FIG. 7.

FIG. 9 is a cross-sectional view showing respective configurations of the nozzle plate, an insulating layer, the actuator plate and the cover plate along the line C-C shown in FIG. 8.

FIG. 10 is a perspective view showing a modified example related to the configuration of the liquid jet head.

### DETAILED DESCRIPTION OF THE PREFERRED EMBODIMENTS

An embodiment of the present disclosure will hereinafter be described in detail with reference to the drawings. It should be noted that the order of the descriptions is as follows.

1. Liquid Jet Recording Device (Liquid Jet Head)
1-1. Configuration of Liquid Jet Recording Device
1-2. Configuration of Liquid Jet Head
1-3. Detailed Configuration of Protective Frame
1-4. Respective Detailed Configurations of Nozzle Plate, Insulating Layer, Actuator Plate and Cover Plate
1-5. Operations
1-6. Functions and Advantages

2. Modified Examples

### 1. Liquid Jet Recording Device (Liquid Jet Head)

A liquid jet recording device of an embodiment of the present disclosure will be described.

It should be noted that the liquid jet head of the embodiment of the present disclosure is a part of the liquid jet recording device described here, and therefore, the liquid jet head will also be described below.

### <1-1. Configuration of Liquid Jet Recording Device>

Firstly, the configuration of the liquid jet recording device will be described.

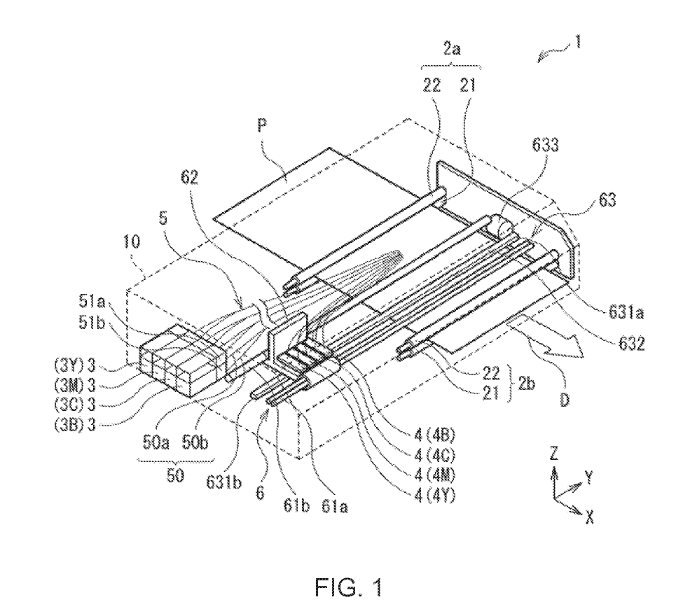

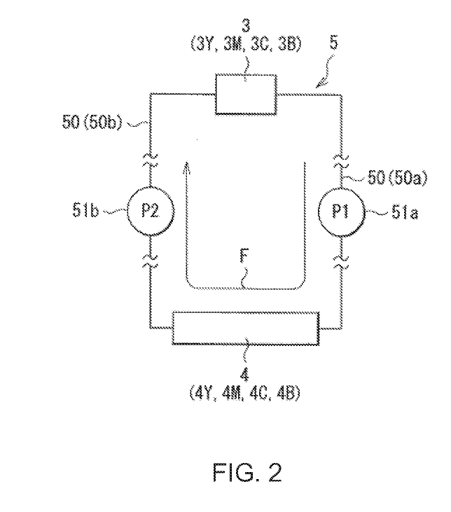

FIG. 1 shows a perspective configuration of a printer 1 as a specific example of the liquid jet recording device. FIG. 2 schematically shows a configuration of the circulation mechanism 5 shown in FIG. 1. It should be noted that in FIG. 1, the inside of a housing 10 is shown by representing an outer edge (contour) of the housing 10 using dotted lines.

This printer 1 is an inkjet type printer for mainly recording (printing) an image, and so on, on recording paper P as a recording target medium using ink 9 as a liquid for recording described later, and is a so-called inkjet printer.

In particular, the printer 1 described here is an inkjet printer of an ink circulation type using the ink 9 circulating in, for example, the circulation mechanism 5.

Specifically, as shown in FIG. 1 and FIG. 2, inside the housing 10, the printer 1 is provided with a pair of carrying mechanisms 2a, 2b, ink tanks 3, inkjet heads 4 as a specific example of the liquid jet head, the circulation mechanism 5, and a scanning mechanism 6.

It should be noted that in FIG. 1 and FIG. 2 and the drawings described later, the scale size of each of the constituents is arbitrarily changed in order to convert the sizes of a series of constituents related to the printer 1 into recognizable sizes.

### [Carrying Mechanisms]

The pair of carrying mechanisms 2a, 2b are each a mechanism for mainly carrying the recording paper P having loaded into the printer 1 in a carrying direction D (an X-axis direction).

The carrying mechanisms 2a, 2b each include a grit roller 21 and a pinch roller 22 as shown in, for example, FIG. 1. The grit rollers 21 and the pinch rollers 22 each extend in, for example, a direction (a Y-axis direction) crossing the carrying direction D, and are each rotatable around the rotational axis extending in that direction. Further, the carrying mechanisms 2a, 2b are each connected to a drive mechanism such as a motor not shown, and each rotate using the power of the drive mechanism.

Here, the planar shape of the recording paper P is, for example, a rectangular shape defined by a pair of long sides opposed to each other, and a pair of short sides opposed to each other. Due to this configuration, the carrying direction D is, for example, a direction (the X-axis direction) along the longitudinal direction of the recording paper P, and at the same time, the direction crossing the carrying direction D is, for example, a direction (the Y-axis direction) along the short-side direction of the recording paper P.

### [Ink Tanks]

The ink tanks 3 are each a liquid storage section for mainly storing the ink 9.

The number of the ink tanks 3 is not particularly limited, and can therefore be just one, or two or more. Here, the printer 1 is provided with, for example, the four ink tanks 3 (3Y, 3M, 3C and 3B) for containing the ink 9 different in color from each other as shown in FIG. 1. The ink tanks 3Y, 3M, 3C and 3B are arranged in this order in, for example, the carrying direction D (the X-axis direction) from the upstream side toward the downstream side.

The ink tank 3Y stores, for example, the yellow (Y) ink 9. The ink tank 3M stores, for example, the magenta (M) ink 9. The ink tank 3C stores, for example, the cyan (C) ink 9. The ink tank 3Y contains, for example, the black (B) ink 9.

The ink tanks 3Y, 3M, 3C and 3B have substantially the same configurations except, for example, the fact that the types (colors) of the ink 9 are different from each other. Hereinafter, the ink tanks 3Y, 3M, 3C and 3B are collectively referred to as the “ink tanks 3” if necessary.

### [Inkjet Heads]

The inkjet heads 4 are each a device (head) for jetting the ink 9 to the recording paper P in order to mainly record an image, and so on, on the recording paper P. In this inkjet head 4, in particular, the ink 9 having a droplet form is jetted to the recording paper P.

The number of the inkjet heads 4 is not particularly limited, and can therefore be just one, or two or more. Here, the printer 1 is provided with, for example, the four inkjet heads 4 (4Y, 4M, 4C and 4B) for jetting the ink 9 different in color from each other in accordance with the four ink tanks 3 (3Y, 3M, 3C and 3B) described above as shown in FIG. 1. The inkjet heads 4Y, 4M, 4C and 4B are arranged in this order in, for example, a direction (the Y-axis direction) crossing the carrying direction D.

The inkjet head 4Y jets, for example, the yellow ink 9. The inkjet head 4M jets, for example, the magenta ink 9. The inkjet head 4C jets, for example, the cyan ink 9. The inkjet head 4B jets, for example, the black ink 9.

The inkjet heads 4Y, 4M, 4C and 4B have substantially the same configurations except, for example, the fact that the types (colors) of the ink 9 are different from each other. Hereinafter, the inkjet heads 4Y, 4M, 4C and 4B are collectively referred to as the “inkjet heads 4” if necessary.

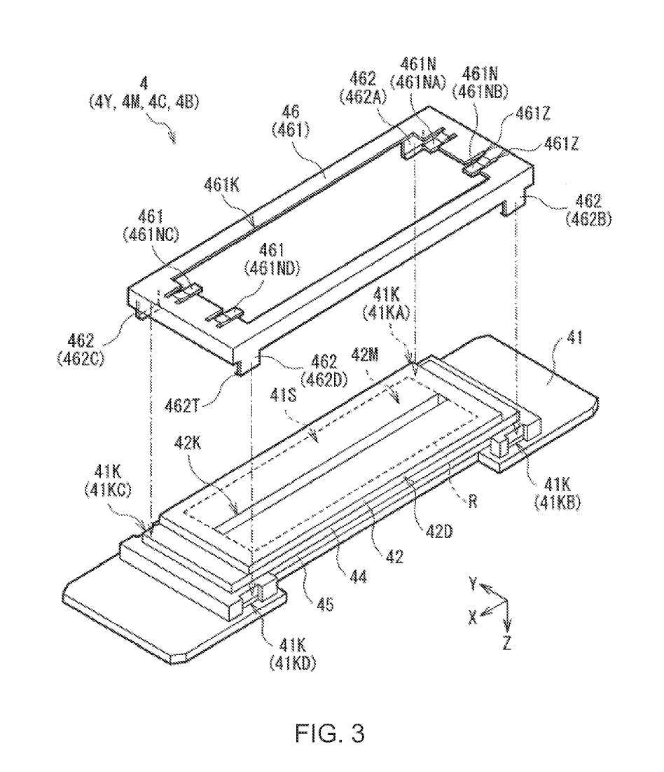

It should be noted that the detailed configuration of the inkjet head 4 will be described later (see FIG. 3 through FIG. 9).

### [Circulation Mechanism]

The circulation mechanism 5 is a mechanism for mainly circulating the ink 9 between the ink tanks 3 and the inkjet heads 4.

As shown in FIG. 2, the circulation mechanism 5 includes, for example, circulation channels 50 of the ink 9, pressure pumps 51a and suction pumps 51b.

The circulation channels 50 each include, for example, a first flow channel 50a through which the ink 9 flows from the ink tank 3 toward the inkjet head 4, and a second flow channel 50b through which the ink 9 flows from the inkjet head 4 toward the ink tank 3.

In each of the first flow channel 50a and the second flow channel 50b, for example, the ink 9 flows inside a tube, and the tube is, for example, a flexible tube having flexibility.

The pressure pump 51a is disposed in, for example, the first flow channel 50a. The pressure pump 51a pressurizes the inside of the first flow channel 50a to thereby supply the inkjet head 4 with the ink 9.

The suction pump 51b is disposed in, for example, the second flow channel 50b. The suction pump 51b reduces the pressure of the inside of the second flow channel 50b to thereby suction the ink 9 from the inkjet head 4.

Thus, in the circulation mechanism 5, for example, the ink 9 flows toward a circulation direction F. Specifically, the ink 9 having supplied from the ink tank 3 flows through, for example, the first flow channel 50a, the inkjet head 4 and the second flow channel 50b in this order to thereby return to the ink tank 3.

### [Scanning Mechanism]

The scanning mechanism 6 is a mechanism for mainly making the inkjet head 4 perform a scanning operation in a direction (the Y-axis direction) crossing the carrying direction D.

As shown in FIG. 1, the scanning mechanism 6 includes, for example, a pair of guide rails 61a, 61b, a carriage 62 and a drive mechanism 63.

The guide rails 61a, 61b each extend in, for example, a direction (the Y-axis direction) crossing the carrying direction D. The carriage 62 is, for example, supported by the guide rails 61a, 61b, and capable of moving in a direction (the Y-axis direction) crossing the carrying direction D along the guide rails 61a, 61b. The drive mechanism 63 includes, for example, a pair of pulleys 631a, 631b, an endless belt 632, and a drive motor 633.

The pair of pulleys 631a, 631b are disposed between, for example, the guide rails 61a, 61b. The pulleys 631a, 631b are disposed at, for example, positions corresponding respectively to the vicinities of the both ends of the guide rails 61a, 61b so as to extend in the Y-axis direction. The belt 632 is wound between, for example, the pulleys 631a, 631b. The belt 632 is connected to, for example, the carriage 62, and on the carriage 62, there is mounted, for example, the inkjet head 4.

By using the carrying mechanisms 2a, 2b and the scanning mechanism 6 as a moving mechanism, the recording paper P and the inkjet head 4 can move relatively to each other.

### <1-2. Configuration of Liquid Jet Head>

Then, a configuration of the inkjet heads 4 will be described.

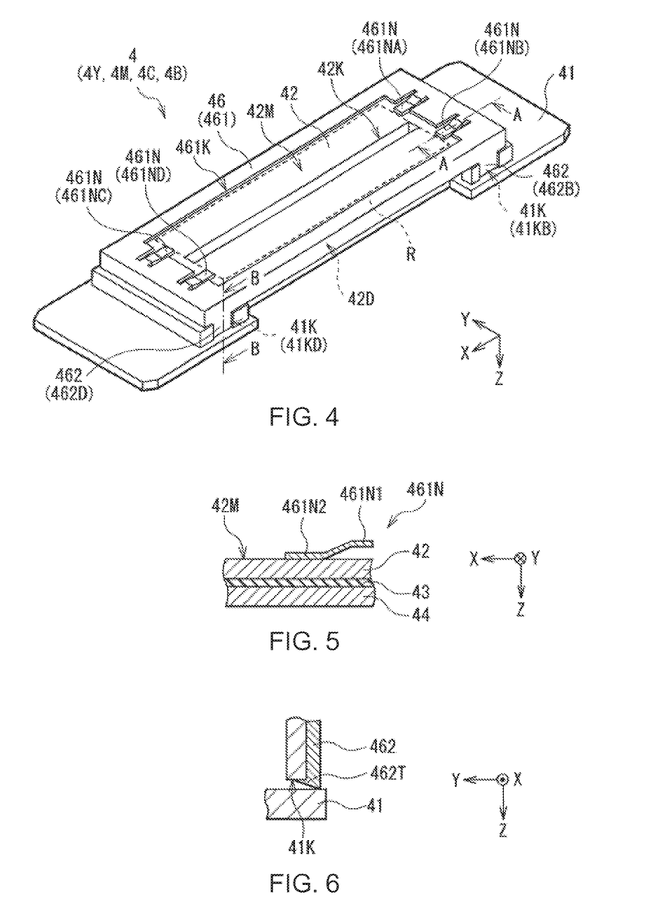

FIG. 3 and FIG. 4 each show a perspective configuration of a principal part (a base 41, a nozzle plate 42, an actuator plate 44, a cover plate 45 and a protective frame 46) in the inkjet head 4 shown in FIG. 1. It should be noted that FIG. 3 shows the state in which the protective frame 46 is detached from the nozzle plate 42, and at the same time, FIG. 4 shows the state in which the protective frame 46 is attached to the nozzle plate 42.

FIG. 5 shows a cross-sectional configuration (a configuration of a cross-section along an X-Z plane) of the inkjet head 4 along the line A-A shown in FIG. 4, and at the same time, FIG. 6 shows a cross-sectional configuration (a configuration of a cross-section along a Y-Z plane) of the inkjet head 4 along the line B-B shown in FIG. 4. It should be noted that although an insulating layer 43 is illustrated in FIG. 5, the illustration of the insulating layer 43 is omitted in each of FIG. 3 and FIG. 4.

As shown in FIG. 3 through FIG. 6, the inkjet head 4 is provided with, for example, the base 41, the nozzle plate (a jet hole plate) 42, the insulating layer 43, the actuator plate 44, the cover plate 45 and the protective frame 46.

The base 41, the nozzle plate 42, the insulating layer 43, the actuator plate 44, the cover plate 45 and the protective frame 46 each extend in, for example, a predetermined extending direction (the X-axis direction). The nozzle plate 42, the insulating layer 43, the actuator plate 44 and the cover plate 45 are mounted on, for example, the base 41, and are at the same time stacked on one another in this order in a Z-axis direction from a side far from the base 41. The protective frame 46 is attached to, for example, the nozzle plate 42.

### [Base]

The base 41 is a support member for supporting mainly the nozzle plate 42 and the actuator plate 44. The nozzle plate 42, the actuator plate 44 and so on are disposed in, for example, a support area 41S disposed in a roughly central area in the extending direction (the X-axis direction) of the base 41 to thereby be aligned with the base 41.

The base 41 includes any one type or two or more types of conductive materials, and has therefore conductivity. The types of the conductive materials are not particularly limited, but are metal materials such as stainless steel (SUS). The types of the stainless steel are not particularly limited, but are, for example, SUS316L and SUS304. It should be noted that the base 41 is electrically separated from the actuator plate 44.

It should be noted that the carriage 62 has conductivity similarly to, for example, the base 41, and at the same time, the inkjet head 4 is mounted on the carriage 62 as described above. Thus, the base 41 abuts on the carriage 62, and is therefore electrically connected (grounded) to the carriage 62.

On a side surface of the base 41, for example, there are disposed insertion openings 41K. Into the insertion openings 41K, for example, there are inserted nail parts 462T of the protective frame 46 (coupling sections 462) described later. The number, positions, and so on of the insertion openings 41K are not particularly limited.

Here, the base 41 has, for example, four insertion openings 41K (41KA, 41KB, 41KC, and 41KD). The insertion openings 41KA, 41KB are disposed on, for example, both side surfaces of the base 41 on one end side in the X-axis direction, and at the same time, the insertion openings 41KC, 41KD are disposed on, for example, both side surfaces of the base 41 on the other end side in the X-axis direction.

### [Nozzle Plate]

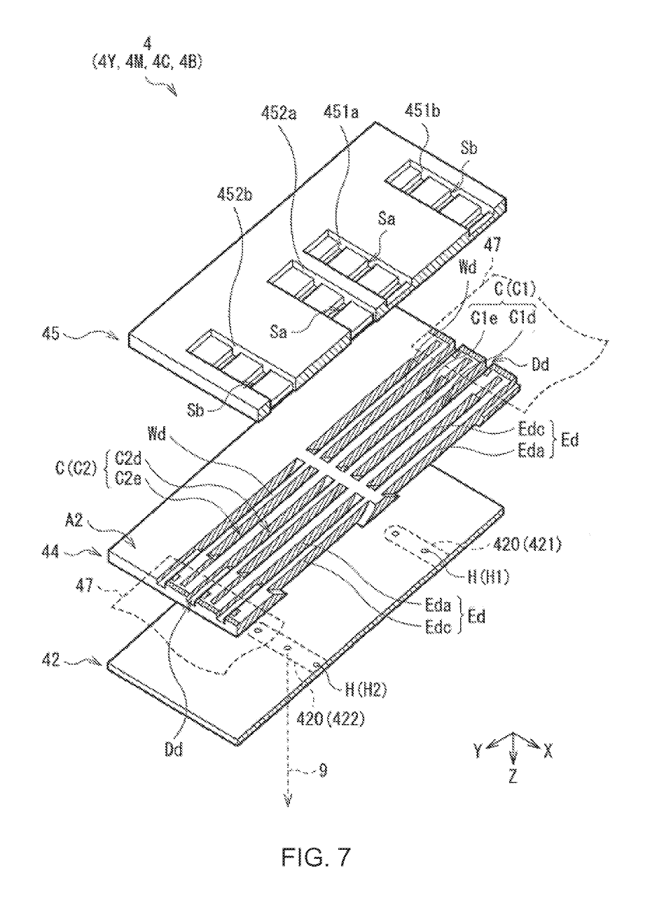

The nozzle plate 42 is a plate mainly provided with a plurality of nozzle holes H (see FIG. 7 through FIG. 9) as jet orifices of the ink 9 described later.

A nozzle area R represented by the dotted lines in each of FIG. 3 and FIG. 4 represents an area in which the plurality of nozzle holes H is disposed in a surface (a jet surface 42M) of the nozzle plate 42 on the side on which the ink 9 is jetted. In other words, the plurality of nozzle holes H is disposed inside the nozzle area R, while the plurality of nozzle holes H is not disposed outside the nozzle area R. Here, the nozzle area R is, for example, a roughly central area of the jet surface 42M.

It should be noted that the nozzle plate 42 has, for example, an opening part 42K in the nozzle area R. The opening part 42K extends in, for example, the X-axis direction, and is used for a variety of purposes such as a purpose for pressure bonding a flexible printed circuit board (FPC) 47 described later.

The nozzle plate 42 includes any one type or two or more types of conductive materials, and has therefore conductivity. The types of the conductive materials are not particularly limited, but are, for example, metal materials similar to the constituent material of the base 41. This is because if the nozzle plate 42 includes the metal material, the metal material has high scratch resistance, and therefore, the physical strength of the nozzle plate 42 (the jet surface 42M) increases.

It should be noted that the nozzle plate 42 having conductivity is separated from the actuator plate 44 having conductivity described later via the insulating layer 43. Therefore, the nozzle plate 42 is electrically insulated from the actuator plate 44 via the insulating layer 43.

It should be noted that the detailed configuration of the nozzle plate 42 will be described later (see FIG. 7 through FIG. 9).

### [Insulating Layer]

The insulating layer 43 is a layer which mainly intervenes between the nozzle plate 42 and the actuator plate 44 to thereby electrically separate (insulate) the nozzle plate 42 and the actuator plate 44 from each other.

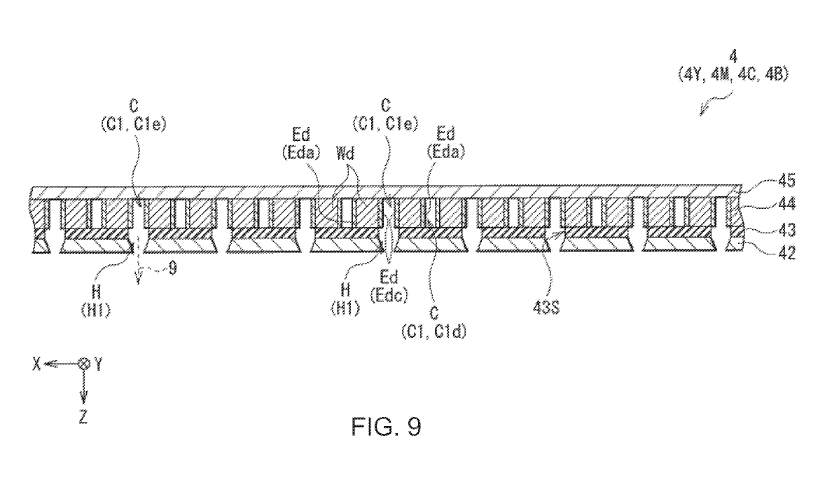

The insulating layer 43 is provided with, for example, a plurality of slits 43S (see FIG. 9) for transmitting the ink 9 described later at positions corresponding respectively to the plurality of nozzle holes H provided to the nozzle plate 42.

Further, the insulating layer 43 includes any one type or two or more types of insulating materials in order to ensure the insulation property. The types of the insulating materials are not particularly limited, but are insulating polymer materials such as polyimide. The insulating layer 43 is, for example, an insulating polymer sheet provided with the plurality of slits 43S.

### [Actuator Plate]

The actuator plate 44 is a plate electrically operating mainly for jetting the ink 9 from the plurality of nozzle holes H.

The actuator plate 44 has a plurality of channels C filled with the ink 9 described later (see FIG. 7 through FIG. 9). The ink 9 filled in the plurality of channels C is jetted from the plurality of nozzle holes H described above.

The actuator plate 44 includes any one type or two or more types of piezoelectric materials. The types of the piezoelectric materials are not particularly limited, but are, for example, lead zirconium titanate (PZT). The actuator plate 44 is, for example, a stacked body having two piezoelectric substrates stacked on one another, the two piezoelectric substrate being configured so that the respective polarization directions in the Z-axis direction are different from each other (a so-called chevron type).

It should be noted that the configuration of the actuator plate 44 is not limited to the chevron type described above. Specifically, the actuator plate 44 can also be, for example, a single piezoelectric substrate which is configured so that the polarization direction in the Z-axis direction is one direction (a so-called cantilever type).

It should be noted that the detailed configuration of the actuator plate 44 will be described later (see FIG. 7 through FIG. 9).

### [Cover Plate]

The cover plate 45 is a plate for mainly introducing the ink 9 into the actuator plate 44 (the plurality of channels C), and at the same time discharging the ink 9 from the actuator plate 44.

The cover plate 45 includes, for example, substantially the same material as the constituent material of the actuator plate 44.

It should be noted that the detailed configuration of the cover plate 45 will be described later (see FIG. 7 through FIG. 9).

### [Protective Frame]

The protective frame 46 is a protective member (a nozzle guard) for mainly protecting a surface of the nozzle plate 42. The “surface” of the nozzle plate 42 described here denotes the surface (the jet surface 42M) of the nozzle plate 42 on the side on which the ink 9 is jetted as described above.

The protective frame 46 covers a part or the whole of an area (a peripheral area surrounding the nozzle area R) except the nozzle area R on the jet surface 42M to thereby protect the jet surface 42M. The reason that the protective frame 46 covers the part or the whole of the peripheral area, in other words, the protective frame 46 does not cover the nozzle area R, is for preventing the plurality of nozzle holes H from being shielded by the protective frame 46.

In particular, the protective frame 46 also has a function as a connection member for electrically connecting the base 41 and the nozzle plate 42 to each other in addition to the function as the protective member described above. In order to ensure the function as the connection member, the protective frame 46 is electrically connected to each of the base 41 and the nozzle plate 42.

It is preferable for the protective frame 46 to be biased to the jet surface 42M to thereby electrically be connected to the nozzle plate 42. This is because if the protective frame 46 is biased to the jet surface 42M, it becomes difficult for the protective frame 46 to be separated from the nozzle plate 42, and therefore, it becomes easy to keep the electrical connection between the protective frame 46 and the nozzle plate 42.

In this case, it is also possible for the protective frame 46 to have point contact with the jet surface 42M, or to have plane contact with the jet surface 42M. In particular, it is preferable for the protective frame 46 to have plane contact with the jet surface 42M. This is because if the protective frame 46 has plane contact with the jet surface 42M, the contact area of the protective frame 46 with the nozzle plate 42 increases compared to the case in which the protective frame 46 has point contact with the jet surface 42M. Thus, it becomes easier to keep the electrical connection between the protective frame 46 and the nozzle plate 42, and at the same time, the electrical conduction state between the protective frame 46 and the base 41 is improved.

It should be noted that the position where the protective frame 46 is biased to the jet surface 42M is not particularly limited. In particular, as described above, in the case (see FIG. 7 through FIG. 9) in which each of the plurality of channels C and the plurality of nozzle holes H is arranged in the X-axis direction, it is preferable for the protective frame 46 to be biased to the jet surface 42M on one end side in the X-axis direction to thereby electrically be connected to the nozzle plate 42 on the one end side, and at the same time, to be biased to the jet surface 42M on the other end side in the X-axis direction to thereby electrically be connected to the nozzle plate 42 on the other end side. This is because if the protective frame 46 is biased to the jet surface 42M in each of the one end side and the other end side in the X-axis direction, the electrical conduction state between the protection frame 46 and the nozzle plate 42 is apt to be homogenized in the X-axis direction even if the plurality of nozzle holes H is arranged in the X-axis direction, and therefore, it becomes difficult for the electrical conduction state to be varied. Thus, it becomes difficult for the jet amount of the ink 9 jetted from the plurality of nozzle holes H and so on to be varied.

Further, the protective frame 46 includes any one type or two or more types of conductive materials in order to ensure the function as the connection member described above, and has therefore conductivity. The types of the conductive materials are not particularly limited, but are, for example, metal materials and conductive polymer materials. The types of the metal materials are not particularly limited, but are stainless steel (SUS) and so on. It should be noted that the details related to the types of the stainless steel are the same as, for example, in the case described with respect to the constituent material (the stainless steel) of the base 41.

### <1-3. Detailed Configuration of Protective Frame>

Then, the detailed configuration of the protective frame 46 will be described.

As shown in FIG. 3 and FIG. 4, the protective frame 46 includes, for example, a cover section 461 and the coupling sections 462. This is because if the protective frame 46 includes the cover section 461 and the coupling sections 462, it is possible to ensure the electrical connection between the protective frame 46 and the base 41 with the coupling sections 462 while sufficiently covering (protecting) the jet surface 42M with the cover section 461.

### [Cover Section]

The cover section 461 is a part which covers the jet surface 42M, and is electrically connected to the nozzle plate 42. The cover section 461 has an opening part 461K at a position corresponding to, for example, the nozzle area R. Thus, the cover section 461 covers the nozzle plate 42 in the peripheral area in the jet surface 42M as described above.

Here, the opening area of the opening part 461K is made larger than, for example, the area of the nozzle area R. Therefore, the cover section 461 covers, for example, a part of the peripheral area described above.

It should be noted that the cover section 461 also covers, for example, side surfaces 42D of the nozzle plate 42 in addition to the jet surface 42M of the nozzle plate 42. Therefore, the cover section 461 is provided with, for example, a roughly box-like solid shape which is opened on the side near to the base 41, and at the same time, provided with the opening part 461K on the side far from the base 41.

The cover section 461 includes connection sections 461N in order to electrically be connected to the nozzle plate 42 (the jet surface 42M). By the connection sections 461N having contact with the jet surface 42M, the cover section 461 is electrically connected to the nozzle plate 42.

It is preferable for the connection section 461N to be biased to the jet surface 42M as described above to thereby electrically be connected to the nozzle plate 42. Here, for example, the cover section 461 is provided with pairs of cut sections 461Z, and a part (the connection section 461N) of the cover section 461 located between each of the pairs of cut sections 461Z is pressed against the jet surface 42M. Thus, the connection sections 461N have, for example, plane contact with the jet surface 42M.

Specifically, as shown in FIG. 5, the connection sections 461N each include, for example, a support part 461N1 and a bent part 461N2. The support part 461N1 is a part coupled to, for example, each of the main body (a part other than the connection sections 461N) of the cover section 461 and the bent part 461N2 to support the bent part 461N2. The bent part 461N2 is a part bent so as to, for example, come closer to the jet surface 42M than the support part 461N1. The connection section 461N including the bent part 461N2 functions as a so-called plate spring, and is therefore biased to the jet surface 42M using the elastic deformation force (restoring force) of the plate spring. The bent part 461N2 has, for example, plane contact with the jet surface 42M as described above.

It should be noted that how the bent part 461N2 is bent is not particularly limited providing the bent part 461N2 is biased to the jet surface 42M using the elastic deformation force of the plate spring described above. Specifically, the bent part 461N2 can be curved, or can also be bent once or two or more times in the middle. Here, the bent part 461N2 is, for example, bent so as to come closer to the jet surface 42M, and then bent again along the jet surface 42M in the direction of getting away from the support part 461N1.

The number of the connection sections 461N is not particularly limited, and can therefore be just one, or two or more. It should be noted that it is preferable for the number of the connection sections 461N to be equal to or larger than two. This is because if the number of the connection sections 461N is equal to or larger than two, the electrical conduction state between the protective frame 46 and the base 41 is further improved. Here, the cover section 461 includes, for example, four connection sections 461N (461NA, 461NB, 461NC, and 461ND).

Further, the positions of the connection sections 461N are not particularly limited. Here, for example, it is preferable for the protective frame 46 to be biased to the jet surface 42M on each of the one end side and the other end side in the X-axis direction as described above. Therefore, for example, the two connection sections 461N (461NA, 461NB) are disposed on the one end side in the X-axis direction, and at the same time, the two connection sections 461N (461NC, 461ND) are disposed on the other end side in the X-axis direction.

It should be noted that it is preferable for each of the connection sections 461NA, 461NB, 461NC, and 461ND to be located at a position shifted from the opening part 42K. This is because if each of the connection sections 461NA, 461NB, 461NC, and 461ND is located at the position shifted from the opening part 42K, it becomes difficult for the opening part 42K to be shielded by each of the connection sections 461NA, 461NB, 461NC, and 461ND. Here, for example, the opening part 42K is disposed between the connection sections 461NA, 461NB in the one end side in the X-axis direction, and at the same time, the opening part 42K is disposed between the connection sections 461NC, 461ND in the other end side in the X-axis direction. Therefore, the connection sections 461NA, 461NC, for example, are disposed so as to be opposed to each other, and at the same time, the connection sections 461NB, 461ND, for example, are disposed so as to be opposed to each other. Obviously, it is preferable for each of the connection sections 461NA, 461NB, 461NC and 461ND to be disposed so as not to overlap the nozzle area R in order not to shield the plurality of nozzle holes H.

### [Coupling Sections]

The coupling sections 462 are each a part to be coupled to each of the cover section 461 and the base 41 to thereby electrically connect the cover section 461 to the base 41. The coupling sections 462 each extend in, for example, the Z-axis direction up to the insertion opening 41K provided to the base 41.

Specifically, the coupling sections 462 each have, for example, a tip part (the nail part) 462T bent inward as shown in FIG. 6. The nail part 462T has, for example, a sharp solid shape, and can be inserted into the insertion opening 41K. Therefore, the protection frame 46 can detachably be attached to the base 41 using, for example, the coupling sections 462 (the nail parts 462T) described above.

In FIG. 3, by detaching the nail parts 462T from the insertion openings 41K, the protective frame 46 is detached from the nozzle plate 42. In contrast, in FIG. 4, by inserting the nail parts 462T into the insertion openings 41K, the protective frame 46 is attached to the nozzle plate 42.

The number of the coupling sections 462 is not particularly limited. Here, for example, since the base 41 has the four insertion openings 41K (41KA, 41 KB, 42KC and 41KD) as described above, the protective frame 46 includes the four coupling sections 462 (462A, 462B, 462C and 462D).

Further, the positions of the coupling sections 462 are not particularly limited. Here, the coupling sections 462A, 462B, 462C and 462D are respectively disposed at, for example, positions corresponding respectively to the insertion openings 41KA, 41KB, 41KC and 41KD.

### <1-4. Respective Detailed Configurations of Nozzle Plate, Insulating Layer, Actuator Plate and Cover Plate>

Then, the respective detailed configurations of the nozzle plate 42, the insulating layer 43, the actuator plate 44 and the cover plate 45 will be described.

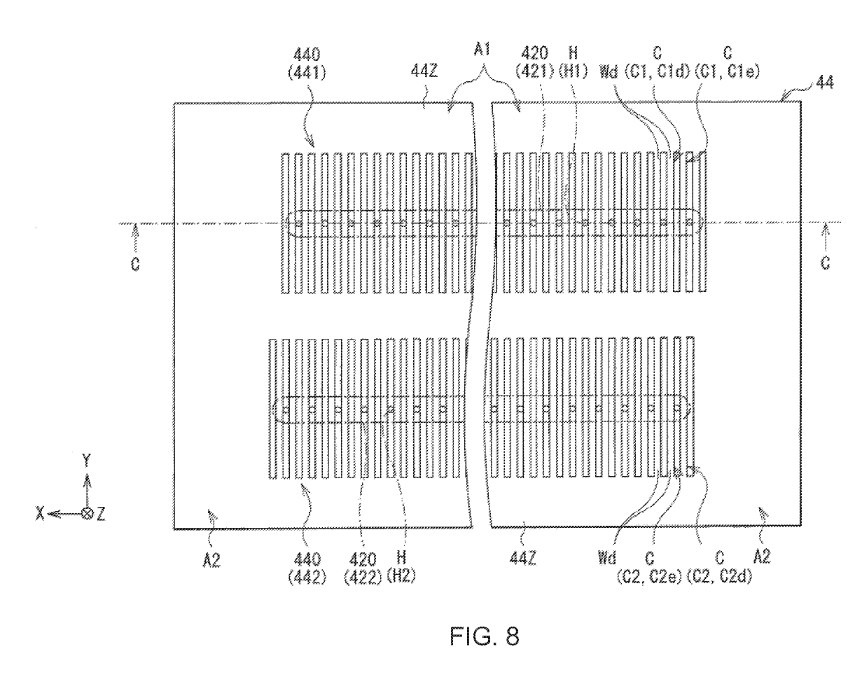

FIG. 7 shows respective perspective configurations of the nozzle plate 42, the actuator plate 44 and the cover plate 45 shown in FIG. 3. FIG. 8 shows a planar configuration of the actuator plate 44 shown in FIG. 7. FIG. 9 shows respective cross-sectional configurations of the nozzle plate 42, the insulating layer 43, the actuator plate 44 and the cover plate 45 along the line C-C shown in FIG. 8.

It should be noted that FIG. 7 shows the state in which the nozzle plate 42, the actuator plate 44 and the cover plate are separated from each other, and at the same time, nozzle columns 421, 422 (a plurality of nozzle holes H1, a plurality of nozzle holes H2) are represented by the dotted lines in FIG. 8.

The inkjet head 4 described here is, for example, a so-called side-shoot type inkjet head 4. In the inkjet head 4 of the side-shoot type, as described later, the channels C provided to the actuator plate 44 extend in the Y-axis direction, and the ink 9 is jetted from each of the nozzle holes H provided to the nozzle plate 42 in the Z-axis direction crossing the Y-axis direction. In this case, the ink 9 is jetted from a roughly central area of each of the channels C extending in the Y-axis direction.

Further, the inkjet head 4 is, for example, a so-called circulation type inkjet head 4, and uses the ink 9 circulated between the ink tank 3 and the inkjet head 4 using the circulation mechanism 5 described above.

### [Nozzle Plate]

The nozzle plate 42 has, for example, a plurality of nozzle columns 420 arranged at a predetermined distance in the Y-axis direction as shown in FIG. 7 through FIG. 9. The nozzle columns 420 each extend in, for example, the X-axis direction, and each include the plurality of nozzle holes H. The opening shape (the shape of the nozzle hole H viewed from the Z-axis direction) of the nozzle hole H is, for example, a circular shape.

Here, the nozzle plate 42 has, for example, two nozzle columns 420 (421, 422). Therefore, the inkjet head 4 is, for example, a so-called two-column type inkjet head 4.

The nozzle column 421 includes, for example, the plurality of nozzle holes H1 arranged at predetermined intervals in the X-axis direction. The nozzle holes H1 each extend in the Z-axis direction so as to penetrate the nozzle plate 42, and are communicated with the respective jet channels C1e of the actuator plate 44 described later. Further, the nozzle holes H1 are each located at a position corresponding to a roughly central area of the jet channel C1e extending in the Y-axis direction. The pitch (the distance between the two nozzle holes H1 adjacent to each other) of the plurality of nozzle holes H1 in the X-axis direction is substantially the same as, for example, the pitch (the distance between the two jet channels C1e adjacent to each other) of the plurality of jet channels C1e in the X-axis direction. Thus, the ink 9 supplied from the jet channels C1e is jetted from the respective nozzle holes H1.

The nozzle column 422 has substantially the same configuration as that of, for example, the nozzle column 421 described above. Specifically, the nozzle column 422 includes, for example, the plurality of nozzle holes H2 arranged at predetermined intervals in the X-axis direction. The nozzle holes H2 each penetrate the nozzle plate 42, and are communicated with the respective jet channels C2e of the actuator plate 44 described later. Further, the nozzle holes H2 are each located at a position corresponding to a roughly central area of the jet channel C2e extending in the Y-axis direction. The pitch (the distance between the two nozzle holes H adjacent to each other) of the plurality of nozzle holes H2 in the X-axis direction is substantially the same as, for example, the pitch (the distance between the two jet channels C2e adjacent to each other) of the plurality of jet channels C2e in the X-axis direction. Thus, the ink 9 supplied from the jet channels C2e is jetted from the respective nozzle holes H2.

The direction in which the ink 9 is jetted from each of the nozzles H1, H2 is a direction (the downward direction in FIG. 7) from the actuator plate 44 toward the nozzle plate 42. The inner diameter of each of the nozzle holes H1, H2 gradually decreases in a direction toward, for example, the jet direction. In other words, each of the nozzle holes H1, H2 is, for example, a penetration orifice having a tapered shape.

### [Insulating Layer]

The insulating layer 43 has, for example, a plurality of slits 43S at positions corresponding respectively to the plurality of nozzle holes H as shown in FIG. 9. The opening shape (the shape of the slit 43S viewed from the Z-axis direction) of the slit 43S is, for example, substantially the same as the shape of the channel C (the jet channel C1e). Specifically, the shape of the slit 43S is, for example, a rectangular shape extending in the Y-axis direction.

### [Actuator Plate]

The actuator plate 44 has, for example, a plurality of channel columns 440 arranged at a predetermined distance in the Y-axis direction as shown in FIG. 7 through FIG. 9. The channel columns 440 each extend in, for example, the X-axis direction, and each include the plurality of channels C. The opening shape (the shape of the channel C viewed from the Z-axis direction) of the channel C is, for example, a rectangular shape extending in the Y-axis direction. Here, the actuator plate 44 has, for example, the two channel columns 440 (441, 442).

In the actuator plate 44, for example, a jet area A1 of the ink 9 is disposed in roughly the central area (an area where the channel columns 441, 442 are formed) in the X-axis direction, and at the same time, non-jet areas A2 of the ink 9 are disposed in both end areas (the areas where the channel columns 441, 442 are not formed) in the X-axis direction. In other words, the non-jet areas A2 are disposed on the outer side of the jet area A1 in the X-axis direction. It should be noted that both end parts of the actuator plate 44 in the Y-axis direction are each a so-called tail part 44Z.

The channel column 441 includes, for example, a plurality of channels C1 extending in the Y-axis direction. The plurality of channels C1 is, for example, arranged at predetermined intervals in the X-axis direction. Each of the channels C1 is partitioned by, for example, drive walls Wd each including a piezoelectric body.

The channel column 442 has substantially the same configuration as that of, for example, the channel column 441 described above. Specifically, the channel column 442 includes, for example, a plurality of channels C2 extending in the Y-axis direction. The plurality of channels C2 is, for example, arranged at predetermined intervals in the X-axis direction. Each of the channels C2 is partitioned by, for example, the drive walls Wd each including a piezoelectric body.

The plurality of channels C1 includes, for example, the jet channels C1e for jetting the ink 9 and dummy channels C1d not jetting the ink 9. In the channel column 441, the jet channels C1e and the dummy channels C1d are alternately arranged along the X-axis direction, for example. The jet channels C1e are communicated with the respective nozzle holes H1 provided to the nozzle plate 42. In contrast, the dummy channels C1d are not communicated with the respective nozzle holes H1, but are shielded by the nozzle plate 42.

The plurality of channels C2 has substantially the same configuration as that of, for example, the plurality of channels C1 described above. Specifically, the plurality of channels C2 includes, for example, the jet channels C2e for jetting the ink 9 and dummy channels C2d not jetting the ink 9. In the channel column 442, the jet channels C2e and the dummy channels C2d are alternately arranged along the X-axis direction, for example. The jet channels C2e are communicated with the respective nozzle holes H2 provided to the nozzle plate 42. In contrast, the dummy channels C2d are not communicated with the respective nozzle holes H2, but are shielded by the nozzle plate 42.

The jet channels C1e and the dummy channels C1d, and the jet channels C2e and the dummy channels C2d are arranged in a staggered manner, for example. In other words, the jet channels C1e, C2e are arranged in a zigzag manner, for example. It should be noted that in the actuator plate 44, in each of the areas corresponding respectively to the dummy channels C1d, C2d, there is disposed, for example, a shallow groove section Dd. The shallow groove section Dd is communicated with an outside end part of each of the dummy channels C1d, C2d extending in the Y-axis direction, for example.

In the actuator plate 44, for example, drive electrodes Ed extending in the Y-axis direction are disposed on inner side surfaces opposed to the drive walls Wd. The drive electrodes Ed include, for example, common electrodes Edc disposed on the respective inner side surfaces of the jet channels C1e, C2e, and active electrodes Eda disposed on the respective inner side surfaces of the dummy channels C1d, C2d. It should be noted that the drive electrodes Ed (the common electrodes Edc and the active electrodes Eda) each extend from one end part of the actuator plate 44 (the drive wall Wd) to the other end part in the Z-axis direction. Therefore, the dimension (the height) of the drive electrode Ed in the Z-axis direction is made roughly equal to, for example, the dimension (the height) of the drive wall Wd in the Z-axis direction.

The pair of common electrodes Edc opposed to each other inside one jet channel C1e (or one jet channel C2e) are, for example, electrically connected to each other via a common terminal. Further, the pair of active electrodes Eda opposed to each other inside one dummy channel C1d (or one dummy channel C2d) are, for example, electrically separated from each other. The pair of active electrodes Eda opposed to each other via the jet channel C1e (or the jet channel C2e) are, for example, electrically connected to each other via an active terminal.

In the tail part 44Z, for example, there is mounted the flexible printed circuit board 47 for electrically connecting the drive electrodes Ed and the inkjet head 4 to each other. It should be noted that in FIG. 7, outer edges (contours) of some parts of the flexible printed circuit board 47 are represented by the dotted lines. Interconnections provided to the flexible printed circuit board 47 are electrically connected to, for example, the common terminals and the active terminals described above, respectively. Thus, the drive voltage is applied to each of the drive electrodes Ed from the inkjet head 4 via the flexible printed circuit board 47.

### [Cover Plate]

The cover plate 45 is, for example, a plate for introducing the ink 9 into the actuator plate 44 (the plurality of channels C), and at the same time discharging the ink 9 from the actuator plate 44 as shown in FIG. 7 through FIG. 9, for example.

The cover plate 45 has, for example, a pair of entrance side common ink chambers 451a, 452a and a pair of exit side common ink chambers 451b, 452b. The entrance side common ink chamber 451a and the exit side common ink chamber 451b are each disposed in, for example, an area corresponding to the channel column 441 (the plurality of channels C1) provided to the actuator plate 44. The entrance side common ink chamber 452a and the exit side common ink chamber 452b are each disposed in, for example, an area corresponding to the channel column 442 (the plurality of channels C2) provided to the actuator plate 44.

The entrance side common ink chamber 451a is a penetration groove formed in the vicinity of an inside end part of each of the channels C1 extending in the Y-axis direction. In the entrance side common ink chamber 451a, in an area corresponding to each of the jet channels C1e, there is formed, for example, a supply slit Sa. Further, the entrance side common ink chamber 452a is a penetration groove formed in the vicinity of an inside end part of each of the channels C2 extending in the Y-axis direction. In the entrance side common ink chamber 452a, in an area corresponding to each of the jet channels C2e, there is formed, for example, the supply slit Sa similarly to the entrance side common ink chamber 451a described above.

The exit side common ink chamber 451b is a penetration groove formed in the vicinity of an outside end part of each of the channels C1 extending in the Y-axis direction. In the exit side common ink chamber 451b, in an area corresponding to each of the jet channels C1e, there is formed, for example, a discharge slit Sb. Further, the exit side common ink chamber 452b is a penetration groove formed in the vicinity of an outside end part of each of the channels C2 extending in the Y-axis direction. In the exit side common ink chamber 452b, in an area corresponding to each of the jet channels C2e, there is formed, for example, the discharge slit Sb similarly to the exit side common ink chamber 451b described above.

The entrance side common ink chamber 451a and the exit side common ink chamber 451b are each communicated with each of the jet channels C1e via the supply slit Sa and the discharge slit Sb on the one hand, but are not communicated with each of the dummy channels C1d on the other hand. Specifically, each of the dummy channels C1d is shielded by the entrance side common ink chamber 451a and the exit side common ink chamber 451b.

The entrance side common ink chamber 452a and the exit side common ink chamber 452b are each communicated with each of the jet channels C2e via the supply slit Sa and the discharge slit Sb on the one hand, but are not communicated with each of the dummy channels C2d on the other hand. Specifically, each of the dummy channels C2d is shielded by the entrance side common ink chamber 452a and the exit side common ink chamber 452b.

### <1-5. Operations>

Then, the operations of the printer 1 will be described.

### [Operations of Printer]

Firstly, an overall operation of the printer 1 will be described. In this printer 1, an image and so on are recorded on the recording paper P in the following procedure.

In the initial state, the ink 9 of the four colors (yellow, magenta, cyan and black) different from each other are respectively contained in the four ink tanks 3 (3Y, 3M, 3C and 3B). The ink 9 is circulated in the circulation mechanism 5 to thereby be supplied to the inkjet head 4.

When the printer 1 operates, the grit rollers 21 of the respective carrying mechanisms 2a, 2b rotate, and therefore, the recording paper P is carried in the carrying direction D due to the grit rollers 21 and the pinch rollers 22. In this case, due to the drive of the drive mechanism 63 (the drive motor 633), the pulleys 631a, 631b rotate to thereby operate the belt 632. Further, the carriage 62 reciprocates in the Y-axis direction using the guide rails 61a, 61b. Thus, since the four colors of ink 9 are jetted from the four inkjet heads 4 (4Y, 4M, 4C and 4B) to the recording paper P, the image and so on are recorded on the recording paper P.

### [Operations of Inkjet Heads]

Then, the operations of the inkjet heads 4 when the printer 1 is in operation will be described. In each of the inkjet heads 4, the ink 9 is jetted to the recording paper P using a shear mode in the following procedure.

Firstly, when the carriage 62 reciprocates, the drive voltages are applied to the drive electrodes Ed (the common electrodes Edc and the active electrodes Eda) in the inkjet head 4 via the flexible printed circuit board 47. Specifically, the drive voltage is applied to the respective drive electrodes Ed provided to the pair of drive walls Wd defining the jet channel C1e, C2e. Thus, the pair of drive walls Wd each deform so as to protrude toward the dummy channel C1d, C2d adjacent to the jet channel C1e, C2e.

Here, as described above, in the actuator plate 44, the two piezoelectric substrates configured so that the polarization directions in the Z-axis direction are different from each other are stacked on one another, and at the same time, the drive electrodes Ed extend in the Z-axis direction from one end part of the drive walls Wd to the other end part. In this case, by applying the drive voltage to the drive electrodes Ed, the drive wall Wd makes flexural deformation taking a roughly middle position of the drive wall Wd in the Z-axis direction as an origination due to the piezoelectric thickness-shear effect. Thus, each of the jet channels C1e, C2e deforms as if it bulges using the flexural deformation of the drive wall Wd described above.

The capacity of each of the jet channels C1e, C2e increases using the flexural deformation of the pair of drive walls Wd based on the piezoelectric thickness-shear effect. Thus, the ink 9 having retained in each of the entrance side common ink chambers 451a, 452a is induced into the inside of each of the jet channels C1e, C2e.

Subsequently, the ink 9 having been induced into the inside of each of the jet channels C1e, C2e propagates to the inside of each of the jet channels C1e, C2e as a pressure wave. In this case, the drive voltage to be applied to the drive electrodes Ed becomes zero (0 V) at the timing at which the pressure wave has reached the nozzle hole H1, H2 provided to the nozzle plate 42. Thus, the drive walls Wd having flexurally deformed are restored to the original state, and therefore, the capacity of each of the jet channels C1e, C2e is restored.

Lastly, when the capacity of each of the jet channels C1e, C2e is restored, the pressure increases in the inside of each of the jet channels C1e, C2e, and therefore, the ink 9 having been induced into the inside of each of the jet channels C1e, C2e is pressurized. Thus, the ink 9 shaped like a droplet is jetted from the nozzle holes H1, H2 toward the outside (the recording paper P).

In this case, for example, since the inner diameter of each of the nozzle holes H1, H2 gradually decreases toward the jet direction as described above, the jet speed of the ink 9 increases, and at the same time, the straightness of the ink 9 is improved. Thus, the quality of the image and so on recorded on the recording paper P is improved.

### <1-6. Functions and Advantages>

Lastly, the functions and the advantages of the printer 1 equipped with the inkjet heads 4 will be described.

### Principal Functions and Advantages

In the printer 1, the nozzle plate 42 having conductivity is electrically insulated from the actuator plate 44 having conductivity, and at the same time, the protective frame 46 having conductivity is electrically connected to each of the nozzle plate 42 having conductivity and the base 41 having conductivity. Therefore, on the grounds described below, it is possible to enhance the operation reliability of the printer 1.

Here, as a printer of a comparative example, there is considered a printer having substantially the same configuration as the printer 1 according to the present embodiment except the fact that the inkjet head 4 is not provided with the protective frame 46.

In the printer of the comparative example not provided with the protective frame 46, if the nozzle plate 42 and the actuator plate 44 are electrically insulated from each other via the insulating layer 43, unwanted capacitance becomes apt to occur between the nozzle plate 42 and the actuator 44. If the unwanted capacitance occurs, the unwanted capacitance becomes apt to exert a harmful influence on the electrical operation of the printer 1, and in particular, the inkjet head 4, and therefore, the inkjet head 4 becomes easy to perform an improper operation.

In contrast, in the printer 1 according to the present embodiment provided with the protective frame 46, by the protective frame 46 electrically connected to each of the nozzle plate 42 and the base 41, the nozzle plate 42 and the base 41 are electrically connected to each other as described above. In this case, even if the nozzle plate 42 and the actuator plate 44 are electrically insulated from each other via the insulating layer 43, it becomes difficult for the unwanted capacitance to occur between the nozzle plate 42 and the actuator 44. Thus, since it becomes difficult for the unwanted capacitance to exert a harmful influence on the electrical operation of the inkjet head 4, the inkjet head 4 becomes difficult to perform an improper operation.

Moreover, since the surface (the jet surface 42M) of the nozzle plate 42 is physically protected by the protective frame 46, it becomes difficult for the nozzle plate 42 to be damaged due to scratch or the like. Thus, since it becomes difficult for the nozzle hole H to be deformed (expanded or contracted) and to be damaged (clogged), a predetermined amount of ink 9 is stably jetted from the nozzle hole H.

Due to these circumstances, it becomes difficult for the unwanted capacitance to occur between the nozzle plate 42 and the actuator plate 44 while physically protecting the nozzle plate 42 having the nozzle holes H. Thus, the improper operation of the inkjet head 4 due to the unwanted capacitance is also prevented while preventing the damage of the nozzle plate 42. Therefore, the operation reliability of the printer 1 can be enhanced.

### Other Functions and Advantages

In particular in the printer 1, if the protective frame 46 is biased to the jet surface 42M, it becomes difficult for the protective frame 46 to be separated from the nozzle plate 42 even if a vibration or the like occurs, and therefore, it becomes easy to keep the electrical connection between the protective frame 46 and the nozzle plate 42. Therefore, a greater advantage can be obtained.

In this case, if the protective frame 46 has plane contact with the jet surface 42M, the contact area of the protective frame 46 with the nozzle plate 42 increases compared to the case in which the protective frame 46 has point contact with the jet surface 42M. Therefore, it becomes easier to keep the electrical connection between the protective frame 46 and the nozzle plate 42, and at the same time, the electrical conduction state between the protective frame 46 and the base 41 is improved. Therefore, a greater advantage can be obtained.

Further, if each of the plurality of channels C and the plurality of nozzle holes H is arranged in the X-axis direction, and the protective frame 46 is electrically connected to the nozzle plate 42 on the one end side in the X-axis direction, and is at the same time electrically connected to the nozzle plate 42 on the other end side in the same direction, the electrical conduction state between the protective frame 46 and the nozzle plate 42 is apt to be homogenized in the X-axis direction. Therefore, the electrical conduction state becomes difficult to be varied. Therefore, since the amount of the ink 9 jetted from the plurality of nozzle holes H and so on become to be varied, a greater advantage can be obtained.

Further, if the protective frame 46 includes the cover section 461 and the coupling sections 462, it is possible to ensure the electrical connection between the protective frame 46 and the base 41 with the coupling sections 462 while sufficiently protecting the jet surface 42M with the cover section 461. Therefore, since the improper operation of the inkjet head 4 is prevented while sufficiently and stably preventing the damage of the nozzle plate 42 and so on, a greater advantage can be obtained.

In this case, if the cover section 461 includes the connection sections 461N biased to the jet surface 42M, the connection sections 461N become difficult to be separated from the nozzle plate 42. Therefore, since the electrical connection between the protective frame 46 and the nozzle plate 42 becomes apt to be maintained, a greater advantage can be obtained. Moreover, if the connection sections 461N have plane contact with the jet surface 42M, the contact area of the connection sections 461N with the nozzle plate 42 increases. Therefore, it becomes easier to keep the electrical connection between the protective frame 46 and the nozzle plate 42, and at the same time, the electrical conduction state between the protective frame 46 and the base 41 is improved. Therefore, a remarkably great advantage can be obtained.

Further, if the coupling sections 462 are detachably attached to the base 41, the protective frame 46 is mounted on the base 41 as needed, and therefore, both of the prevention of the damage of the nozzle plate 42 and the prevention of the improper operation of the inkjet head 4 due to the occurrence of the unwanted capacitance are easily achieved. Therefore, a greater advantage can be obtained.

Further, if the protective frame 46 includes a metal material or the like, conductivity of the protective frame 46 is ensured, and therefore, a greater advantage can be obtained.

It should be noted that the functions and the advantages related to the printer 1 described above can also be obtained with respect to the inkjet head 4 in a similar manner.

### 2. Modified Examples

The configuration of each of the printer 1 and the inkjet head 4 described above can arbitrarily be changed. It should be noted that regarding the series of modified examples described below, any two or more types can also be combined with each other.

### Modified Example 1

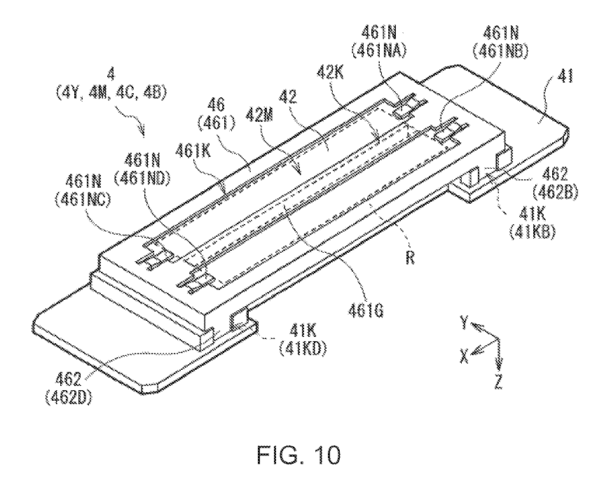

Specifically, in the case in which the nozzle plate 42 has the opening part 42K as shown in FIG. 4, for example, it is also possible for the protective frame 46 (the cover section 461) to have a shield part 461G as shown in FIG. 10 corresponding to FIG. 4. The shield part 461G, for example, extends in the X-axis direction, and at the same time, shields the opening part 42K. Thus, the cover section 461 having the shield part 461G covers, for example, the peripheral area in the jet surface 42M, and at the same time covers the opening part 42K. It should be noted that the dimension of the shield part 461G in the Y-axis direction is not particularly limited, but in particular, it is preferable for the dimension of the shield part 461G in the Y-axis direction to be as small as possible within the range in which the shield part 461G can shield the opening part 42K.

The reason is that by setting the dimension of the shield part 461G in the Y-axis direction as small as possible, the shield part 461G is prevented from shielding the plurality of nozzle holes H.

In this case, even if the nozzle plate 42 is provided with the opening part 42K, the opening part 42K is shielded by the protective frame 46, and therefore, the ink 9 is prevented from entering the opening part 42K. Therefore, since the improper operation of the inkjet head 4 due to the entry of the unwanted ink 9 is prevented, it is possible to further enhance the operation reliability of the printer 1.

### Modified Example 2

Further, it is assumed that the coupling sections 462 are detachably attached to the base 41 as shown in FIG. 3 and FIG. 4, it is also possible to fix the coupling sections 462 to the base 41 to thereby make the protective frame 46 unable to be detached from the base 41. Also in this case, by electrically connecting the nozzle plate 42 and the base 41 to each other via the protective frame 46, it is possible to obtain substantially the same advantage.

It should be noted that it is preferable for the protective frame 46 (the coupling sections 462) to be detachably attached to the base 41. This is because if the protective frame 46 is detachably attached to the base 41, the protective frame 46 can be detached from the nozzle plate 42 as needed, and therefore, it is possible to easily perform the maintenance of the nozzle plate 42.

Further, if the protective frame 46 is detachably attached to the base 41, the following advantages can also be obtained. By providing an allowance (a dimensional margin) to the dimension of the insertion opening 41K to which the nail part 462T is inserted, the nail part 462T is made to be displaced inside the insertion opening 41K. In this case, in the case in which the nozzle plate 42 and so on expand thermally due to heat generation and so on, the protection frame 46 is displaced so as to follow the thermal expansion.

Therefore, it becomes difficult for the protective frame 46 to be separated from the nozzle plate 42, and at the same time, it becomes difficult for the protective frame 46 to be damaged.

### Modified Example 3

Further, although the insulating polymer sheet provided with the plurality of slits 43S is used as the insulating layer 43 as shown in FIG. 9, the configuration of the insulating layer 43 is not particularly limited.

Specifically, the insulating layer 43 can also be, for example, an evaporated film having an insulation property which is formed on a surface (a surface on the side opposed to the nozzle plate 42) of the actuator plate 44 after forming the actuator plate 44 having the plurality of channels C. The insulating layer 43 formed of the evaporated film includes any one type or two or more types of insulating materials such as poly-paraxylene (so-called parylene).

In the case in which the insulating layer 43 is formed, for example, it is also possible to arrange that the insulating layer 43 covers not only the surface of the drive wall Wd, but also the side surfaces (the drive power Ed) of the drive wall Wd. Further, in the case in which the insulating layer 43 is formed, it is also possible to arrange that the insulating layer 43 is not formed in not only the area corresponding to the jet channels C1e, but also the area corresponding to the dummy channels C1d.

Also in this case, the insulating layer 43 having the plurality of slits 43S is formed. Thus, since the nozzle plate 42 and the actuator plate 44 are electrically insulated from each other via the insulating layer 43, and at the same time, the nozzle plate 42 and the base 41 are electrically connected to each other via the protective frame 46, substantially the same advantage can be obtained.

### Modified Example 4

Besides the above, the types and so on of each of the printer 1 and the inkjet head 4 can arbitrarily be changed. Further, the shape, the layout, the number and so on related to the series of constituents of each of the printer 1 and the inkjet head 4 can arbitrarily be changed.

Specifically, for example, although the two-column type inkjet head 4 having the two nozzle columns 420 (421, 422) has been described, this is not a limitation, and it is also possible to adopt a single column type inkjet head 4 having just one column, or a multi-column type inkjet head 4 having three or more nozzle columns.

Further, for example, although there has been described the case in which each of the nozzle columns 421, 422 extends in the X-axis direction, this is not a limitation, and it is also possible for each of the nozzle columns 421, 422 to extend in an oblique direction with respect to the X-axis direction, or to extend in other directions. It should be noted that, for example, although there has been described the case in which the opening shape of each of the nozzle holes H1, H2 is the circular shape, this is not a limitation, and the opening shape of each of the nozzle holes H1, H2 can also be a roughly circular shape such as an elliptical shape, a polygonal shape such as a triangular shape, or other shapes.

Further, for example, although the channel columns 440 formed of the two channel columns (441, 442) have been described in accordance with the nozzle columns 420 formed of the two nozzle columns (421, 422) described above, this is not a limitation. The number of columns of the channel columns 440 can be one, or three or more in accordance with the number of columns of the nozzle columns 420.

### Modified Example 5

Further, for example, it is also possible to add a variety of mechanisms to the printer 1. Specifically, for example, it is also possible to install a wiping mechanism and so on not shown in the drawings to the printer 1. The wiping mechanism is, for example, a mechanism for removing unnecessary ink 9 adhering to the jet surface 42M.

Although the description regarding the present disclosure has been presented hereinabove citing the embodiment, the configuration of the present disclosure is not limited to the configuration explained in the embodiment described above, but a variety of modifications can be adopted.

Specifically, for example, instead of jetting a single color of ink from a single inkjet head, it is also possible for the single inkjet head to jet a plurality of colors (e.g., two colors) of ink different from each other.

Further, for example, the inkjet head is not limited to the side-shoot type inkjet head, but can also be an edge-shoot type inkjet head. In the edge-shoot type inkjet head, each of the channels provided to the actuator plate extends in the Y-axis direction, and the ink is jetted in the Y-axis direction from each of the nozzle holes provided to the nozzle plate.

Further, for example, the inkjet head is not limited to the ink circulation type inkjet head using the circulation mechanism, but can also be an ink non-circulation type inkjet head not using the circulation mechanism.

Further, for example, the purposes to which each of the liquid jet head and the liquid jet recording device of the present disclosure is applied are not limited to the inkjet printer, but can also be other purposes. The other purposes can also be other devices such as a facsimile or an on-demand printing machine.

It should be noted that the advantages described in the specification are illustrative only but are not a limitation, and other advantages can also be provided.

Further, the present disclosure can also take the following configurations.

<1>

A liquid jet head comprising an actuator plate having conductivity and a plurality of channels filled with liquid; a nozzle plate having conductivity which is electrically insulated from the actuator plate, and has a plurality of nozzle holes from which the liquid filled in the plurality of channels is jetted; a base having conductivity adapted to support each of the actuator plate and the nozzle plate; and a protective member having conductivity, adapted to cover at least a part of a surface of the nozzle plate in an area where the plurality of nozzle holes is not disposed on a side from which the liquid is jetted, and electrically connected to each of the nozzle plate and the base.

<2>

The liquid jet head according to <1>, wherein the protective member is biased to the surface of the nozzle plate to thereby be electrically connected to the nozzle plate.

<3>

The liquid jet head according to <2>, wherein the protective member has plane contact with the surface of the nozzle plate.

<4>

The liquid jet head according to any one of <1> to <3>, wherein the actuator plate, the nozzle plate and the protective member each extend in a predetermined extending direction, each of the plurality of channels and the plurality of nozzle holes is arranged in the extending direction, and the protective member is electrically connected to the nozzle plate on one end side in the extending direction, and is electrically connected to the nozzle plate on the other end side in the extending direction.

<5>

The liquid jet head according to any one of <1> to <4>, wherein the plurality of nozzle holes is disposed in a central area in the surface of the nozzle plate, and the protective member includes a cover section adapted to cover the surface of the nozzle plate in a peripheral area on a periphery of the central area, and electrically connected to the nozzle plate, and a coupling section coupled to each of the cover section and the base, and electrically connected to the base.

<6>

The liquid jet head according to <5>, wherein the protective member includes a connection section biased to the surface of the nozzle plate, and electrically connected to the nozzle plate.

<7>

The liquid jet head according to <6>, wherein the connection section has plane contact with the surface of the nozzle plate.

<8>

The liquid jet head according to any one of <5> to <7>, wherein the coupling section is detachably attached to the base.

<9>

The liquid jet head according to any one of <5> to <8>, wherein the nozzle plate has an opening part in the central area, and the cover section covers the opening part in addition to the surface of the nozzle plate in the peripheral area.

<10>

The liquid jet head according to any one of <1> to <9>, wherein the protective member includes at least one of a metal material and a conductive polymer material.

<11>

A liquid jet recording device comprising the liquid jet head according to any one of <1> to <10>, and adapted to jet the liquid to a recording target medium; and a liquid storage section adapted to store the liquid.

What is claimed is:

1. A liquid jet head comprising:
an actuator plate having conductivity and a plurality of channels filled with liquid;
a nozzle plate having conductivity which is electrically insulated from the actuator plate, and has a plurality of nozzle holes from which the liquid filled in the plurality of channels is jetted;
a base having conductivity adapted to support each of the actuator plate and the nozzle plate; and
a protective member having conductivity, adapted to cover at least a part of a surface of the nozzle plate in an area where the plurality of nozzle holes is not disposed on a side from which the liquid is jetted, and electrically connected to each of the nozzle plate and the base.

2. The liquid jet head according to claim 1, wherein
the protective member is biased to the surface of the nozzle plate to thereby be electrically connected to the nozzle plate.

3. The liquid jet head according to claim 2, wherein
the protective member has plane contact with the surface of the nozzle plate.

4. The liquid jet head according to claim 1, wherein
the actuator plate, the nozzle plate and the protective member each extend in a predetermined extending direction,
each of the plurality of channels and the plurality of nozzle holes is arranged in the extending direction, and
the protective member is electrically connected to the nozzle plate on one end side in the extending direction, and is electrically connected to the nozzle plate on the other end side in the extending direction.

5. The liquid jet head according to claim 1, wherein
the plurality of nozzle holes is disposed in a central area in the surface of the nozzle plate, and
the protective member includes
a cover section adapted to cover the surface of the nozzle plate in a peripheral area on a periphery of the central area, and electrically connected to the nozzle plate, and
a coupling section coupled to each of the cover section and the base, and electrically connected to the base.

6. The liquid jet head according to claim 5, wherein
the protective member includes a connection section biased to the surface of the nozzle plate, and electrically connected to the nozzle plate.

7. The liquid jet head according to claim 6, wherein
the connection section has plane contact with the surface of the nozzle plate.

8. The liquid jet head according to claim 5, wherein
the coupling section is detachably attached to the base.

9. The liquid jet head according to claim 5, wherein
the nozzle plate has an opening part in the central area, and
the cover section covers the opening part in addition to the surface of the nozzle plate in the peripheral area.

10. The liquid jet head according to claim 1, wherein
the protective member includes at least one of a metal material and a conductive polymer material.

11. A liquid jet recording device comprising:
the liquid jet head according to claim 1, and adapted to jet the liquid to a recording target medium; and
a liquid storage section adapted to store the liquid.
